(19) United States
(12) Patent Application Publication
(10) Pub. No.: US 2014/0220216 A1
(43) Pub. Date: Aug. 7, 2014

(54) BEVERAGE COMPOSITION

(71) Applicant: FUJIFILM Corporation, Tokyo (JP)

(72) Inventor: Masao SATO, Ashigarakami-gun (JP)

(73) Assignee: FUJIFILM Corporation, Tokyo (JP)

(21) Appl. No.: 14/245,752

(22) Filed: Apr. 4, 2014

Related U.S. Application Data
(63) Continuation of application No. PCT/JP2012/075505, filed on Oct. 2, 2012.

(30) Foreign Application Priority Data
Oct. 7, 2011 (JP) 2011-223319

(51) Int. Cl. A23L 2/66; A23L 2/60

(52) U.S. Cl. CPC A23L 2/66; A23L 2/60
USPC 426/548; 426/590

(57) ABSTRACT

There is provided a beverage composition including a collagen peptide having a high concentration and having moderately acidic taste and excellent flavor in a pH range of the pH 4.0 or less. A beverage composition including 2,000 mg/10 mL or more of a low molecular collagen peptide having an average molecular weight of 3,000 or less and two or more kinds of acidifiers containing phosphoric acid, in which the pH is 4.0 or less.

### BACKGROUND OF THE INVENTION

1. Field of the Invention

The present invention relates to a beverage composition.

2. Description of the Related Art

A collagen is an animal protein which has been used as gelatin in a food field in the related art, however, since a collagen is a main component of dermis, connective tissue, or the like, a collagen is also particularly getting attention from the aspect of a medical field and a beauty field in recent years. In addition, in order to effectively use a collagen which is ingested in the body, a food and a beverage containing a collagen peptide in which a polymeric collagen is decomposed into low molecular weight have been also developed. Furthermore, in order to obtain a high effect, a beverage which is blended with 10,000 mg of the collagen peptide per one bottle is becoming the main current.

In a beverage using such a collagen peptide, there exists a problem in terms of palatability caused by having an odor peculiar to the collagen peptide. In particular, in a case of blending with 10,000 mg of the collagen peptide per one bottle, the odor is particularly emphasized since a concentration of the collagen peptide becomes higher than usual.

In this manner, as to a beverage containing the collagen peptide having an unpleasant smell, for example, a technique which realizes a health beverage having excellent flavor by using two or more kinds of essences including an adlay essence or the like, an acidulant, a fruit-based flavor, or the like in a beverage containing various types of nutrients including a collagen hydrolyzate is disclosed in JP1993-199855A (JP-H05-199855A). In addition, in order to suppress coagulation and sedimentation due to minerals or the like generated in a beverage including fruit juice, in addition to the suppression of an unpleasant smell of the collagen peptide, a technique of using fruit juice and phosphoric acid or a phosphoric acid salt in addition to the collagen peptide is disclosed in WO2007/125888A. In WO2007/125888A, it is described that it is possible to suppress an unpleasant smell and obtain an oral liquid composition having good flavor and excellent preservation stability by blending fruit juice such as concentrated grape juice with a phosphoric acid salt such as sodium metaphosphate.

On the other hand, the beverage containing such a collagen peptide is classified as a refreshing drink and the heat treatment is performed for the purpose of sterilizing. The conditions of sterilizing are largely distinguished by the pH of the beverage, and yeast or mold in an acidic region and a bacterial spore in a neutral pH region are respectively set to a subject for sterilization. There is not a storage standard, and a method of heating at 65° C. or more of the temperature in the center part for 10 minutes or more as to the sterilization for one having the pH less than 4.0 and a method of heating at 85° C. or more for 30 minutes or more as to the sterilization for one having the pH from 4.0 to 4.6, as a manufacturing standard for one for which the sterilization is required, are described in the Food Sanitation Act in Japan, and for the purpose of imparting the antiseptic property to the beverage to make it a safe beverage, there exists another problem in which the pH of the beverage itself is suppressed low.

In addition, as to a beverage containing such a collagen peptide having a high concentration, a beverage in which the pH is adjusted to 4.0 or less using citric acid or ascorbic acid is disclosed in JP2011-103822A. In this Patent Document, a technique in which the viscosity of the beverage is optimally kept and the beverage is allowed to have a flavor using a flavor such as yoghurt is disclosed for the purpose of making both textures (a feeling of effect and a feeling of satisfaction when putting into the mouth) of a state in which the beverage is chilled in the refrigerator and a state in which the beverage is kept at room temperature excellent.

### SUMMARY OF THE INVENTION

By the way, it has been known that the collagen peptide has pH buffering ability. In a case of containing the collagen peptide having a high concentration, it becomes difficult to ignore the pH buffering ability in which the collagen peptide has. In particular, it was proven that a harmful effect in which the flavor is spoiled occurs since an acidic taste is strongly felt owing to excessive used amount of an acidifier, in a case where there was need for using a large amount of acid as means for realizing the low pH in which the pH is 4.0 or less for the purpose of maintaining the antiseptic property.

Therefore, in the present invention, an object thereof is to provide a beverage composition containing a collagen peptide having a high concentration and realizing moderately acidic taste and excellent flavor in a pH range of the pH 4.0 or less which has an effect on the antiseptic property.

The present invention is as follows.

[1] A beverage composition including 2,000 mg/10 mL or more of a low molecular collagen peptide having an average molecular weight of 3,000 or less and two or more kinds of acidifiers containing phosphoric acid, in which the pH is 4.0 or less.

[2] The beverage composition according to [1], in which a concentration of the phosphoric acid is from 20 mg/10 mL to 200 mg/10 mL with respect to a volume of the composition.

[3] The beverage composition according to [1] or [2], in which the acidifier includes at least one kind selected from a group consisting of phosphoric acid, citric acid, tartaric acid, malic acid, ascorbic acid, lactic acid, succinic acid and fumaric acid.

[4] The beverage composition according to any of [1] to [3] further including at least one kind of amino acid selected from a group consisting of lysine, proline and ornithine.

[5] The beverage composition according to any of [1] to [4] further including at least one kind of a sweetener with high sweetness degree selected from a group consisting of aspartame, thaumatin, stevia, sucralose and acesulfame potassium.

[6] A packaged beverage including the beverage composition according to any of [1] to [5].

According to the present invention, there is provided a beverage composition containing a collagen peptide having a high concentration and having moderately acidic taste and excellent flavor in a pH range of the pH 4.0 or less.

### DESCRIPTION OF THE PREFERRED EMBODIMENTS

The beverage composition according to the present invention is a beverage composition which includes 2,000 mg/10 mL or more of a low molecular collagen peptide having an average molecular weight of 3,000 or less and two or more kinds of acidifiers containing phosphoric acid, in which the pH is 4.0 or less.

According to the present invention, since the beverage composition includes the low molecular collagen peptide having a predetermined average molecular weight in a high concentration which is 2,000 mg/10 mL or more and includes phosphoric acid and other acidifier as an acidifier, a collagen peptide beverage composition having moderately acidic taste and excellent flavor can be provided, even the pH is 4 or less.

To explain this in detail, in the beverage composition, in a case where the beverage composition including the low molecular collagen peptide having the average molecular weight of 3,000 or less in a high concentration which is 2,000 mg/10 mL or more is adjusted to the pH 4.0 or less by setting a part of the acidifier to phosphoric acid, it becomes possible to suppress an excessive acidic taste and keep the antiseptic property, even the collagen peptide has the pH buffering ability.

In the present specification, the term “step” includes a step which is difficult to clearly distinguish from other step as long as the intended action in the present step is achieved, in addition to an independent step.

In addition, in the present invention, a numerical range indicated using “to” indicates a range including numerical values described before and after “to” respectively as a minimum value and a maximum value.

In addition, in the present invention, in a case of referring to the amount or concentration of each component in the composition, the amount or concentration means the total amount of a plurality of substances which exist in the composition in a case where a plurality of substances falling under each component exist in the composition, unless otherwise specified.

Hereinafter, description will be given of the present invention.

The collagen peptide is a low molecular weight collagen peptide having the average molecular weight of 3,000 or less. By setting the average molecular weight to 3,000 or less, there is a tendency that the absorbability of the collagen peptide increases when being ingested as a food and a beverage and it is possible to avoid generating a big difference between the viscous properties at room temperature and in cold storage. The average molecular weight of the collagen peptide is preferably 500 to 3,000, and further preferably 1,000 to 3,000. By setting the average molecular weight to 500 or more, there is a tendency that it is possible to obtain the viscous property having a preferred texture.

The average molecular weight of the collagen peptide means a value which is measured by using a gel permeation chromatography (GPC: polyethylene glycol (PEG) standard), however, in a case of a commercial product, it is sufficient to follow the product information provided from a supply source.

To determine the average molecular weight by the GPC, the average molecular weight is calculated based on the calibration curve of the relationship between the retention time obtained by measuring several different kinds of polyethylene glycols (PEG) in which the molecular weights are known in advance under the same conditions and the molecular weight. The average molecular weight in the present invention indicates a weight average molecular weight which is calculated in terms of PEG in accordance with this method.

The collagen peptide is one obtained by hydrolyzing gelatin with an enzyme or an acid, is a protein containing a lot of glycine, and is available as a commercial product. The collagen may be a collagen extracted from a collagen tissue of mammals or a collagen extracted from a collagen tissue of fish, and they are not particularly limited. In recent years, from the viewpoint of a commodity image, the safety, or the like, the collagen derived from fish is preferable. A material of the collagen derived from fish may be a saltwater fish or a freshwater fish, and a skin of a tuna (yellowfin tuna), a shark, a cod, a bastard halibut, a flounder, a sea bream, a tilapia, a salmon, a catfish, or the like is included. The collagen derived from these fish is one extracted from a scale or a skin of fish, and has characteristics in which the content of proline, lysine, or the like is small, compared to the collagen of human beings or other animals. As a material of the collagen derived from mammals, a pig, cattle and the like are included.

The concentration of the collagen peptide is 2,000 mg/10 mL or more. By setting to 2,000 mg/10 mL or more, it is possible to effectively use the collagen peptide in the body. The concentration of the collagen peptide is not particularly limited as long as the concentration of the collagen peptide is 2,000 mg/10 mL or more with respect to the volume of the beverage composition, however, the concentration of the collagen peptide is preferably from 2,000 mg/10 mL to 4,000 mg/10 mL, and further preferably from 2,500 mg/10 mL to 3,500 mg/10 mL. By setting to 4,000 mg/10 mL or less, it is possible to set to the viscosity within an acceptable range as a beverage.

The beverage composition includes two or more kinds of acidifiers containing phosphoric acid. In doing so, it is possible to set the pH of a solution to 4.0 or less while suppressing the acidic taste and it is possible to realize moderately acidic taste and excellent flavor. Phosphoric acid capable of being used in the beverage composition can be used without particular limitation as long as phosphoric acid is capable of being used as a food and a beverage. However, a phosphoric acid salt such as sodium metaphosphate is unable to set the pH of the beverage composition to 4.0 or less while keeping moderately acidic taste and excellent flavor.

The concentration of phosphoric acid in the beverage composition is preferably 20 mg/10 mL to 200 mg/10 mL, and more preferably 25 mg/10 mL to 130 mg/10 mL, with respect to the volume of the beverage composition. By setting to 20 mg/10 mL or more, there is a tendency that moderately acidic taste is obtained, and by setting to 200 mg/10 mL or less, there is a tendency that unnatural bitter taste is easily suppressed.

The acidifier except phosphoric acid is not particularly limited as long as the acidifier is an acidifier capable of being used with respect to the beverage, particularly an acidifier which is suitable for use with respect to a refreshing drink, and acetic acid, gluconic acid, citric acid, tartaric acid, malic acid, ascorbic acid, lactic acid, succinic acid, fumaric acid, and the like can be used. Among those, the acidifier in which it is possible to realize the preferred flavor in the present invention is citric acid, tartaric acid, malic acid, ascorbic acid, lactic acid, succinic acid or fumaric acid, among those, citric acid, tartaric acid, malic acid or ascorbic acid is more preferable from the viewpoint of the balance between stimulation and a refreshing feeling as a beverage, and citric acid, tartaric acid or malic acid is further preferable from the viewpoint of the pH adjusting ability. These acidifiers except phosphoric acid may be used as one kind alone or may be used in combination of two or more kinds thereof.

The concentration of the acidifier except phosphoric acid in the beverage composition is preferably 10 mg/10 mL to 800 mg/10 mL, and more preferably 20 mg/10 mL to 350 mg/10 mL with respect to the volume of the beverage composition. By setting to 10 mg/10 mL or more, it is possible to obtain moderately acidic taste using phosphoric acid together, and by setting to 800 mg/10 mL or less, there is a tendency that it is possible to sufficiently suppress an excessive acidic taste or stimulation.

The total amount of the acidifier containing the phosphoric acid can be changed in accordance with the concentration of the collagen peptide. The present invention is characterized by the concentration of the collagen peptide being 2,000 mg/10 mL or more, as described above, since the collagen peptide in a range of this concentration has the strong pH buffering ability, it is possible to appropriately set the total amount of the acidifier in accordance with the concentration of the collagen peptide. The total amount of the acidifier containing phosphoric acid is preferably 50 mg/10 mL to 600 mg/10 mL, more preferably 80 mg/10 mL to 500 mg/10 mL, and further preferably 100 mg/10 mL to 400 mg/10 mL with respect to the volume of the beverage composition. By setting to 50 mg/10 mL or more, there is a tendency that the flavor of the beverage composition is improved, and by setting to 600 mg/10 mL or less, there is a tendency that it is possible to realize moderately acidic taste.

In addition, in a case of changing the concentration of the collagen peptide, it is preferred to change the ratio of the acidifier except phosphoric acid to phosphoric acid in order to balance with the odor peculiar to the collagen peptide and impart excellent flavor. The content rate of phosphoric acid varies depending on the concentration of the collagen peptide, the kind of the acidifier used, or the like in the beverage composition, however, the content rate of phosphoric acid, for example can be set to within a range from 9% by weight to 85% by weight to the entirety of the acidifier.

The beverage composition preferably includes at least one amino acid selected from a group consisting of lysine, proline and ornithine. Lysine, proline and ornithine which are a kind of amino acid are known as a constituent component of the collagen or a synthesis promoting component of the collagen, and it is excepted that the generation efficiency and the utilization efficiency of the collagen in the body are further enhanced by adding these additional amino acids in the body. Moreover, as to amino acid used in the present invention, only L-body is used.

In particular, in a case of using the low molecular weight collagen peptide derived from fish as the collagen peptide, in order to more effectively enhance the utilization efficiency of the collagen, it is preferred to use the amino acid together, among those, it is further preferred to use lysine together.

The concentration of the amino acid described above in the beverage composition is preferably 10 mg/10 mL to 200 mg/10 mL, and more preferably 30 mg/10 mL to 100 mg/10 mL, with respect to the volume of the beverage composition. If the concentration of the amino acid is 10 mg/10 mL or more, there is a tendency that the collagen peptide is effectively used, and if the concentration of the amino acid is 200 mg/10 mL or less, it is possible to suppress the flavor peculiar to amino acid.

In order to adjust to the beverage having further preferred flavor, the beverage composition preferably includes at least one kind selected from a group consisting of a sweetener with high sweetness degree and a sweetener except a sweetener with high sweetness degree.

The sweetener with high sweetness degree is a general term for a synthetic sweetener or a natural sweetener having the sweetness of several tens of times to several thousand times of sugar. As an example of the sweetener with high sweetness degree, there is no limitation in a range in which it is possible to preferably adjust the flavor, however, in the present invention, aspartame, thaumatin, stevia, sucralose or acesulfame potassium can be preferably used, and acesulfame potassium or sucralose is further preferable. The sweetener with high sweetness degree may be used as one kind alone or may be used in combination of two or more kinds thereof.

The concentration of the sweetener with high sweetness degree in the beverage composition is preferably 1 mg/10 mL to 50 mg/10 mL, and more preferably 3 mg/10 mL to 25 mg/10 mL. If the concentration of the sweetener with high sweetness degree is 1 mg/10 mL or more, there is a tendency that moderate sweetness can be achieved, and if the concentration of the sweetener with high sweetness degree is 50 mg/10 mL or less, there is a tendency that moderate flavor can be achieved.

As the sweetness except the sweetener with high sweetness degree, saccharides, a sugar alcohol and powdered sugar are included. As the saccharides, monosaccharides such as glucose, fructose, galactose or an isomerized sugar; disaccharides such as sugar, lactose or palatinose; oligosaccharides such as fructo-oligosaccharide, isomalt-oligosaccharide or galacto-oligosaccharide, and the like are included. As the sugar alcohol, monosaccharide alcohols such as erythritol, xylitol, sorbitol or mannitol; disaccharide alcohols such as maltitol, isomaltitol, lactitol, or the like; trisaccharide alcohols such as maltotriitol, isomaltotriitol or panitol; tetra or more saccharide alcohols such as an oligosaccharide alcohol; a sugar alcohol such as powdered reducing maltose syrup, and the like are included. As the sweetener, glucose, powdered sugar, erythritol, xylitol and sorbitol are more preferable, furthermore, erythritol is most preferable. These sweeteners may be used as one kind alone and may be in combination of two or more kinds thereof.

The concentration of the sweetener except the sweetener with high sweetness degree in the beverage composition is preferably 100 mg/10 mL to 5,000 mg/10 mL, and more preferably 300 mg/10 mL to 2,500 mg/10 mL. The sweetener may be used as one kind alone or may be used in combination of two or more kinds thereof.

In addition, in the beverage composition, the sweetener with high sweetness degree and the sweetener apart from that may be respectively used alone and may be used in combination thereof. As the beverage composition, the sweetener with high sweetness degree and the sweetener apart from the sweetener with high sweetness degree can be preferably used together.

In order to adjust the flavor, the beverage composition can preferably further include a fragrance. As the fragrance, any fragrance of yogurt, sugar, lychee, peach, mango, pineapple, raspberry, blueberry, cranberry and pear is preferable.

The concentration of the fragrance in the beverage composition is preferably 10 μL/10 mL to 200 μL/10 mL, and more preferably 30 μL/10 mL to 100 μL/10 mL.

The beverage composition may include a functional oily component. The functional oily component means an oily component in which the induction of a predetermined physiological effect in the applied living bodies can be expected in a case of applying it to living bodies. As an example of the functional oily component, carotenoids such as β-carotene, astaxanthin, lutein or lycopene; an unsaturated fatty acid such as linolenic acid, eicosapentaenoic acid (EPA), docosahexaenoic acid (DHA), squalene, squalane or fish oil containing them; coenzyme Q10, and the like are included.

The beverage composition may include other additive components. As such an additive component, various vitamins, a mineral, a coloring agent, an antioxidant, a stabilizer, a preservative, an emulsifier, an antifoam, and the like are included.

It is preferred that the viscosity of the beverage composition be in a range from 10 mPa·s to 35 mPa·s at room temperature (25° C.) and in a range from 20 mPas·s to 50 mPa·s at 4° C. If the viscosity of the beverage composition is in the ranges, it is possible to realize an excellent texture in a case of drinking as kept at room temperature or drinking by being cooled, it is therefore desired. By setting to 10 mPa·s or more at room temperature or 20 mPa·s or more at 4° C., there is a tendency to become the viscosity in which the texture is not too smooth and a sufficient feeling of satisfaction is provided as the texture when being drunk. In addition, by setting to 35 mPa·s or less at room temperature or 50 mPa-s or less at 4° C., there is a tendency to become a viscosity that is easy to drink. That is, by setting to within the ranges described above, there is a tendency that it is possible to realize excellent texture.

Here, the viscosity of the beverage composition can be measured by using a rotary viscometer.

The pH of the beverage composition is 4.0 or less. When the pH exceeds 4.0, an effect of the antiseptic property is reduced. Moreover, in a case of the beverage composition in which the pH exceeds 4.0, since a stronger heat treatment becomes necessary in a manufacturing step according to the Food Sanitation Act, there is a tendency to spoil the flavor and a tendency to deteriorate the components. The pH of the beverage composition is preferably from 3.0 to 4.0, and the pH is further preferably from 3.4 to 4.0. By setting the pH to 3.0 or more, there is a tendency that it is possible to suppress an increase in amount of the acidifier used when the pH is adjusted.

A method of manufacturing the beverage composition includes mixing 2000 mg/10 mL or more of the low molecular collagen peptide having the average molecular weight of 3,000 or less and two or more kinds of acidifiers containing phosphoric acid (a mixing step), and adjusting the pH to 4.0 or less (a pH adjusting step).

In doing so, it is possible to adjust the beverage composition according to the present invention described before.

The mixing step includes mixing each component configuring the beverage composition. Each component has to be mixed with respect to the preferred aqueous medium. As an aqueous medium which is used, water is usually used. The mixing of each component is not particularly limited, and the mixing step is performed at a temperature in which each component is sufficiently dissolved, for example, within a temperature range from 20° C. to 80° C. The mixing is preferably performed while stirring. In addition, the addition order of each component is not particularly limited as long as an addition order is in a range in which each component is uniformly mixed.

As described above, since the beverage composition is required to be adjusted to within the predetermined pH range due to containing phosphoric acid and the acidifier, the pH adjusting step may be performed at the same time as the mixing step. In addition, the pH adjusting step may be separately and independently performed after the mixing step, as necessary.

The method of manufacturing the beverage composition can include another steps other than the above, as necessary. As such an additional step, a viscosity adjusting step, a filtering step, and the like are included. A viscosity adjusting step and a filtering step have to apply a well-known method in the related art.

In addition, the beverage composition may be also set to a packaged beverage containing the composition. The packaged beverage is obtained by filling a container with the beverage composition. The container used for the present packaged beverage has to be one which is usually used as a container for beverage, and for example, a PET bottle, a drink box, a glass container, an aluminum can, a steel can, a pouch, and the like are included.

### EXAMPLE

Hereinafter, description will be given of the present invention in detail in Example. However, the present invention is not limited thereto, in any way. Moreover, “part” is based on mass, unless otherwise specified.

### Preparation of Beverage Composition

### Example 1

200 mg of L-lysine, 1,000 mg of erythritol, 7.2 mg of sucralose and 8.4 mg of acesulfame potassium were added to 10,000 mg of the collagen peptide having the average molecular weight of 2,700, and 400 mg of L-ascorbic acid, 250 mg of citric acid, 350 mg of L-tartaric acid and 130 mg of phosphoric acid were further added. 15 mL of water was added thereto, the solution was heated and dissolved at 50° C., a fragrance was added after being dissolved, afterwards, water was additionally added to adjust the total volume to 30 mL and the beverage composition was prepared.

When the pH of the obtained beverage composition was measured, the pH was 3.88.

### Examples 2 to 47

The beverage compositions were prepared using all same procedures as Example 1 except changing each raw material and the blending amounts thereof as shown in Table 1, Table 2, Table 5 and Table 7.

### Comparative Examples 1 to 44

The beverage compositions were prepared using all same procedures as Example 1 except changing each raw material and the blending amounts thereof as shown in Table 3, Table 4, Table 6 and Table 8.

(pH Measurement)

As to the beverage compositions in Examples 1 to 47 and Comparative Examples 1 to 44, the pH was measured at 25° C. The results are shown in Table 1 to Table 8.

(Evaluation of Flavor)

As to the beverage compositions in Examples 1 to 47 and Comparative Examples 1 to 44, the evaluation of the flavor was conducted as to one in which the pH was 4.0 or less.

As to the evaluation of the flavor, by tasting each beverage in Examples and Comparative Examples, the sensory evaluation of the flavor was performed from the viewpoint of a refreshing feeling and stimulation of the acidic taste. When the flavor was excellent, it was evaluated as A, when a refreshing feeling was slightly insufficient but the flavor was good, it was evaluated as B, when the flavor was fair, it was evaluated as C, when the flavor was an allowable level, it was evaluated as D and in a case where there was a problem as a product, it was evaluated as E.

The results are shown in Table 1 to Table 8. Moreover, in Table 1 to Table 8, “*A” means fair as the flavor while there is a feeling that slightly sticks into the tongue and “*B” means fair as a flavor while a refreshing feeling and stimulation are slightly insufficient. “*C*” means that a flavor is allowed while feeling an acidic taste with a sharp taste. In addition, “*D” means that a refreshing feeling and stimulation are low and the flavor is too light and “*E” means that a refreshing feeling and stimulation are low and a bitter flavor is slightly felt. “*F” means that the flavor is not evaluated since the pH exceeds 4.0.

TABLE 1

| | Example 1 | Example 2 | Example 3 | Example 4 | Example 5 | Example 6 | Example 7 | Example 8 |
|---|---|---|---|---|---|---|---|---|
| Collagen peptide | 10000 mg | ← | ← | ← | ← | ← | ← | ← |
| Phosphoric acid | 130 mg | 130 mg | 130 mg | 130 mg | 130 mg | 130 mg | 130 mg | 130 mg |
| L-ascorbic acid | 400 mg | 200 mg | | | | | | |
| Citric acid | 250 mg | 400 mg | 750 mg | 1000 mg | | | | |
| Tartaric acid | 350 mg | 400 mg | | | 500 mg | 750 mg | | |
| Malic acid | | | | | | | 750 mg | |
| Succinic acid | | | | | | | | |
| Fumaric acid | | | | | | | | 750 mg |
| Lactic acid | | | | | | | | |
| L-lysine | 200 mg | ← | ← | ← | ← | ← | ← | ← |
| Erythritol | 1000 mg | ← | ← | ← | ← | ← | ← | ← |
| Sucralose | 7.2 mg | ← | ← | ← | ← | ← | ← | ← |
| Acesulfame K | 8.4 mg | ← | ← | ← | ← | ← | ← | ← |
| Fragrance | appropriate | ← | ← | ← | ← | ← | ← | ← |
| Water | appropriate | ← | ← | ← | ← | ← | ← | ← |
| Liquid measure | 30 mL | ← | ← | ← | ← | ← | ← | ← |
| Liquid pII | 3.88 | 3.49 | 3.99 | 3.85 | 3.98 | 3.75 | 3.94 | 3.67 |
| Evaluation | A | A | A | A | A | A | A | *A |

| | Example 8 | Example 9 | Example 10 | Example 11 | Example 12 | Example 13 | Example 14 |
|---|---|---|---|---|---|---|---|
| Collagen peptide | ← | ← | ← | ← | ← | ← | ← |
| Phosphoric acid | 130 mg | 130 mg | 130 mg | 90 mg | 90 mg | 90 mg | 90 mg |
| L-ascorbic acid | | | | | | | |
| Citric acid | | | | 900 mg | | | |
| Tartaric acid | | | | | 650 mg | 800 mg | |
| Malic acid | | | | | | | 750 mg |
| Succinic acid | | | 1250 mg | | | | |
| Fumaric acid | 750 mg | | | | | | |
| Lactic acid | | 1000 mg | | | | | |
| L-lysine | ← | ← | ← | ← | ← | ← | ← |
| Erythritol | ← | ← | ← | ← | ← | ← | ← |
| Sucralose | ← | ← | ← | ← | ← | ← | ← |
| Acesulfame K | ← | ← | ← | ← | ← | ← | ← |
| Fragrance | ← | ← | ← | ← | ← | ← | ← |
| Water | ← | ← | ← | ← | ← | ← | ← |
| Liquid measure | ← | ← | ← | ← | ← | ← | ← |
| Liquid pII | 3.67 | 3.92 | 3.95 | 3.96 | 3.86 | 3.72 | 3.96 |
| Evaluation | *A | *B | *C | A | A | A | A |

TABLE 2

| | Exam | Exam- | Exam- | Exam- | Exam- | Exam- | Exam- | Exam- | Exam- |
|---|---|---|---|---|---|---|---|---|---|
| | ple 15 | ple 16 | ple 17 | ple 18 | ple 19 | ple 20 | ple 21 | ple 22 | ple 23 |
| Collagen | 10000 mg | ← | ← | ← | ← | ← | ← | ← | ← |
| peptide | | | | | | | | | |
| Phosphoric acid | 180 mg | 180 mg | 180 mg | 350 mg | 350 mg | 350 mg | 500 mg | 500 mg | 500 mg |
| Sodium | | | | | | | | | |
| metaphosphate | | | | | | | | | |
| Potassium | | | | | | | | | |
| metaphosphate | | | | | | | | | |
| Sodium | | | | | | | | | |
| pyrophosphate | | | | | | | | | |
| decahydrate | | | | | | | | | |
| L-ascorbic acid | | | | | | | | | |
| Citric acid | 750 mg | | | 600 mg | | | 350 mg | | |
| Tartaric acid | | 650 mg | | | 600 mg | | | 300 mg | |
| Malic acid | | | 650 mg | | | 600 mg | | | 350 mg |
| Succinic acid | | | | | | | | | |
| Fumaric acid | | | | | | | | | |
| Lactic acid | | | | | | | | | |
| L-lysine | 200 mg | ← | ← | ← | ← | ← | ← | ← | ← |
| Erythritol | 1000 mg | ← | ← | ← | ← | ← | ← | ← | ← |
| Sucralose | 7.2 mg | ← | ← | ← | ← | ← | ← | ← | ← |
| Acesulfame K | 8.4 mg | ← | ← | ← | ← | ← | ← | ← | ← |
| Fragrance | appropriate | ← | ← | ← | ← | ← | ← | ← | ← |
| Water | appropriate | ← | ← | ← | ← | ← | ← | ← | ← |
| Liquid measure | 30 mL | ← | ← | ← | ← | ← | ← | ← | ← |
| Liquid pH | 3.99 | 3.78 | 3.95 | 3.89 | 3.64 | 3.82 | 3.90 | 3.74 | 3.85 |
| Evaluation | A | A | A | A | A | A | B | B | B |

TABLE 3

| | Compar- | Compar- | Compar- | Compar- | Compar- | Compar- | Compar- | Compar- | Compar- | Compar- |
|---|---|---|---|---|---|---|---|---|---|---|
| | ative | ative | ative | ative | ative | ative | ative | ative | ative | ative |
| | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 7 | ple 8 | ple 9 | ple 10 |
| Collagen | 10000 mg | ← | ← | ← | ← | ← | ← | ← | ← | ← |
| peptide | | | | | | | | | | |
| Phosphoric | 130 mg | 130 mg | 130 mg | 130 mg | 130 mg | 130 mg | 90 mg | | | |
| acid | | | | | | | | | | |
| L-ascorbic | 1000 mg | 1500 mg | | | | | | | | |
| acid | | | | | | | | | | |
| Citric acid | | | 500 mg | | | | 650 mg | 1100 mg | | |
| Tartaric acid | | | | | | | | | 1000 mg | |
| Malic acid | | | | | | | | | | 1000 mg |
| Succinic acid | | | | 750 mg | 1000 mg | | | | | |
| Fumaric acid | | | | | | | | | | |
| Lactic acid | | | | | | 750 mg | | | | |
| L-lysine | 200 mg | ← | ← | ← | ← | ← | ← | ← | ← | ← |
| Erythritol | 1000 mg | ← | ← | ← | ← | ← | ← | ← | ← | ← |
| Sucralose | 7.2 mg | ← | ← | ← | ← | ← | ← | ← | ← | ← |
| Acesulfame K | 8.4 mg | ← | ← | ← | ← | ← | ← | ← | ← | ← |
| Fragrance | appropriate | ← | ← | ← | ← | ← | ← | ← | ← | ← |
| Water | appropriate | ← | ← | ← | ← | ← | ← | ← | ← | ← |
| Liquid | 30 mL | ← | ← | ← | ← | ← | ← | ← | ← | ← |
| measure | | | | | | | | | | |
| Liquid pH | 4.29 | 4.12 | 4.12 | 4.20 | 4.06 | 4.11 | 4.17 | 3.98 | 3.65 | 3.88 |
| Evaluation | *F | *F | *F | *F | *F | *F | *F | E | E | E |

TABLE 4

| | Compar- | Compar- | Compar- | Compar- | Compar- | Compar- | Compar- | Compar- | Compar- | Compar- | Compar- |
|---|---|---|---|---|---|---|---|---|---|---|---|
| | ative | ative | ative | ative | ative | ative | ative | ative | ative | ative | ative |
| | Exam- | Exam- | Exam- | Exam- | Exam- | Exam- | Exam- | Exam- | Exam- | Exam- | Exam- |
| | ple 11 | ple 12 | ple 13 | ple 14 | ple 15 | ple 16 | ple 17 | ple 18 | ple 19 | ple 20 | ple 21 |
| Collagen | 10000 mg | ← | ← | ← | ← | ← | ← | ← | ← | ← | ← |
| peptide | | | | | | | | | | | |
| Phosphoric | 750 mg | 1000 mg | | | | | | | | | |
| acid | | | | | | | | | | | |
| Sodium | | | 130 mg | 750 mg | | | | | | | |
| metaphosphate | | | | | | | | | | | |
| Potassium | | | | | 130 mg | | | | | | |
| metaphosphate | | | | | | | | | | | |
| Sodium | | | | | | 130 mg | 600 mg | | | | |
| pyrophosphate | | | | | | | | | | | |
| decahydrate | | | | | | | | | | | |
| L-ascorbic | | | 400 mg | 400 mg | 400 mg | 400 mg | 400 mg | | | | |
| acid | | | | | | | | | | | |
| Citric acid | | | 250 mg | 250 mg | 250 mg | 250 mg | 250 mg | 500 mg | 500 mg | | 500 mg |
| Tartaric acid | | | 350 mg | 350 mg | 350 mg | 350 mg | 350 mg | 500 mg | | 500 mg | |
| Malic acid | | | | | | | | | 500 mg | 500 mg | |
| Succinic acid | | | | | | | | | | | |
| Fumaric acid | | | | | | | | | | | 500 mg |
| Lactic acid | | | | | | | | | | | |
| L-lysine | 200 mg | ← | ← | ← | ← | ← | ← | ← | ← | ← | ← |
| Erythritol | 1000 mg | ← | ← | ← | ← | ← | ← | ← | ← | ← | ← |
| Sucralose | 7.2 mg | ← | ← | ← | ← | ← | ← | ← | ← | ← | ← |
| Acesulfame K | 8.4 mg | ← | ← | ← | ← | ← | ← | ← | ← | ← | ← |
| Fragrance | appropriate | ← | ← | ← | ← | ← | ← | ← | ← | ← | ← |
| Water | appropriate | ← | ← | ← | ← | ← | ← | ← | ← | ← | ← |
| Liquid | 30 mL | ← | ← | ← | ← | ← | ← | ← | ← | ← | ← |
| measure | | | | | | | | | | | |
| Liquid pH | 3.86 | 3.55 | 4.06 | 4.11 | 4.01 | 4.07 | 4.30 | 3.76 | 3.86 | 3.71 | 3.71 |
| Evaluation | *D | *E | *F | *F | *F | *F | *F | E | E | E | E |

TABLE 5

| | Example 24 | Example 25 | Example 26 | Example 27 | Example 28 | Example 29 |
|---|---|---|---|---|---|---|
| Collagen peptide | 12500 mg | ← | ← | ← | ← | ← |
| Phosphoric acid | 180 mg | 180 mg | 180 mg | 340 mg | 340 mg | 340 mg |
| L-ascorbic acid | | | | | | |
| Citric acid | 1100 mg | | | 800 mg | | |
| Tartaric acid | | 1100 mg | | | 800 mg | |
| Malic acid | | | 1100 mg | | | 800 mg |
| Succinic acid | | | | | | |
| Fumaric acid | | | | | | |
| Lactic acid | | | | | | |
| L-lysine | 250 mg | ← | ← | ← | ← | ← |
| Erythritol | 1500 mg | ← | ← | ← | ← | ← |
| Sucralose | 9 mg | ← | ← | ← | ← | ← |
| Acesulfame K | 10 mg | ← | ← | ← | ← | ← |
| Fragnance | appropriate | ← | ← | ← | ← | ← |
| Water | appropriate | ← | ← | ← | ← | ← |
| Liquid measure | 50 mL | ← | ← | ← | ← | ← |
| Liquid pH | 3.89 | 3.56 | 3.70 | 3.91 | 3.65 | 3.81 |
| Evaluation | A | A | A | A | A | A |
| | Example 30 | Example 31 | Example 32 | Example 33 | Example 34 | Example 35 |
| Collagen peptide | ← | ← | ← | ← | ← | ← |
| Phosphoric acid | 340 mg | 340 mg | 340 mg | 700 mg | 700 mg | 700 mg |
| L-ascorbic acid | | | | | | |
| Citric acid | | | | 300 mg | | |
| Tartaric acid | | | | | 300 mg | |
| Malic acid | | | | | | 300 mg |
| Succinic acid | 1300 mg | | | | | |
| Fumaric acid | | 800 mg | | | | |
| Lactic acid | | | 1300 mg | | | |
| L-lysine | ← | ← | ← | ← | ← | ← |
| Erythritol | ← | ← | ← | ← | ← | ← |
| Sucralose | ← | ← | ← | ← | ← | ← |
| Acesulfame K | ← | ← | ← | ← | ← | ← |
| Fragnance | ← | ← | ← | ← | ← | ← |
| Water | ← | ← | ← | ← | ← | ← |
| Liquid measure | ← | ← | ← | ← | ← | ← |
| Liquid pH | 3.98 | 3.59 | 3.82 | 3.89 | 3.72 | 3.79 |
| Evaluation | *C | *A | *B | B | B | B |

TABLE 6

| | Comparative | Comparative | Comparative | Comparative | Comparative | Comparative |
|---|---|---|---|---|---|---|
| | Example 22 | Example 23 | Example 24 | Example 25 | Example 26 | Example 27 |
| Collagen peptide | 12500 mg | ← | ← | ← | ← | ← |
| Phosphoric acid | | | | | 1000 mg | |
| Sodium metaphosphate | | | | | | 180 mg |
| Potassium metaphosphate | | | | | | |
| Sodium pyrophosphate | | | | | | |
| decahydrate | | | | | | |
| L-ascorbic acid | 2500 mg | | | | | |
| Citric acid | | 1500 mg | | | | 1100 mg |
| Tartaric acid | | | 1500 mg | | | |
| Malic acid | | | | 1500 mg | | |
| Succinic acid | | | | | | |
| Fumaric acid | | | | | | |
| Lactic acid | | | | | | |
| L-lysine | 250 mg | ← | ← | ← | ← | ← |
| Erythritol | 1500 mg | ← | ← | ← | ← | ← |
| Sucralose | 9 mg | ← | ← | ← | ← | ← |
| Acesulfame K | 10 mg | ← | 4- | ← | ← | ← |
| Fragrance | appropriate | ← | ← | ← | ← | ← |
| Water | appropriate | ← | ← | ← | ← | ← |
| Liquid measure | 50 mL | ← | ← | ← | ← | ← |
| Liquid pH | 4.06 | 3.82 | 3.45 | 3.70 | 3.77 | 4.06 |
| Evaluation | *F | E | E | E | *E | *F |
| | Comparative | Comparative | Comparative | Comparative | Comparative | Comparative |
| | Example 28 | Example 29 | Example 30 | Example 31 | Example 32 | Example 33 |
| Collagen peptide | ← | ← | ← | ← | ← | ← |
| Phosphoric acid | | | | | | |
| Sodium metaphosphate | | | | | | |
| Potassium metaphosphate | 180 mg | | | | | |
| Sodium pyrophosphate | | 180 mg | | | | |
| decahydrate | | | | | | |
| L-ascorbic acid | | | | | | |
| Citric acid | 1100 mg | 1100 mg | 700 mg | 700 mg | | 700 mg |
| Tartaric acid | | | 700 mg | | 700 mg | |
| Malic acid | | | | 700 mg | 700 mg | |
| Succinic acid | | | | | | |
| Fumaric acid | | | | | | 700 mg |
| Lactic acid | | | | | | |
| L-lysine | ← | ← | ← | ← | ← | ← |
| Erythritol | ← | ← | ← | ← | ← | ← |
| Sucralose | ← | ← | ← | ← | ← | ← |
| Acesulfame K | ← | ← | ← | ← | ← | ← |
| Fragrance | ← | ← | ← | ← | ← | ← |
| Water | ← | ← | ← | ← | ← | ← |
| Liquid measure | ← | ← | ← | ← | ← | ← |
| Liquid pH | 4.05 | 4.12 | 3.72 | 3.78 | 3.66 | 3.44 |
| Evaluation | *F | *F | E | E | E | E |

TABLE 7

| | Example 36 | Example 37 | Example 38 | Example 39 | Example 40 | Example 41 |
|---|---|---|---|---|---|---|
| Collagen peptide | 10000 mg | ← | ← | ← | ← | ← |
| Phosphoric acid | 180 mg | 180 mg | 180 mg | 340 mg | 340 mg | 340 mg |
| L-ascorbic acid | | | | | | |
| Citric acid | 900 mg | | | 400 mg | | |
| Tartaric acid | | 900 mg | | | 300 mg | |
| Malic acid | | | 900 mg | | | 400 mg |
| Succinic acid | | | | | | |
| Fumaric acid | | | | | | |
| Lactic acid | | | | | | |
| L-lysine | 200 mg | ← | ← | ← | ← | ← |
| Erythritol | 1200 mg | ← | ← | ← | ← | ← |
| Sucralose | 7.2 mg | ← | ← | ← | ← | ← |
| Acesulfame K | 8.4 mg | ← | ← | ← | ← | ← |
| Fragrance | appropriate | ← | ← | ← | ← | ← |
| Water | appropriate | ← | ← | ← | ← | ← |
| Liquid measure | 50 mL | ← | ← | ← | ← | ← |
| Liquid pH | 3.81 | 3.51 | 3.70 | 3.98 | 3.93 | 3.91 |
| Evaluation | A | A | A | A | A | A |
| | Example 42 | Example 43 | Example 44 | Example 45 | Example 46 | Example 47 |
| Collagen peptide | ← | ← | ← | ← | ← | ← |
| Phosphoric acid | 340 mg | 340 mg | 340 mg | 500 mg | 500 mg | 500 mg |
| L-ascorbic acid | | | | | | |
| Citric acid | | | | 200 mg | | |
| Tartaric acid | | | | | 100 mg | |
| Malic acid | | | | | | 200 mg |
| Succinic acid | 800 mg | | | | | |
| Fumaric acid | | 300 mg | | | | |
| Lactic acid | | | 600 mg | | | |
| L-lysine | ← | ← | ← | ← | ← | ← |
| Erythritol | ← | ← | ← | ← | ← | ← |
| Sucralose | ← | ← | ← | ← | ← | ← |
| Acesulfame K | ← | ← | ← | ← | ← | ← |
| Fragrance | ← | ← | ← | ← | ← | ← |
| Water | ← | ← | ← | ← | ← | ← |
| Liquid measure | ← | ← | ← | ← | ← | ← |
| Liquid pH | 3.96 | 3.84 | 3.95 | 3.94 | 3.97 | 3.86 |
| Evaluation | *C | *A | *B | A | A | A |

TABLE 8

| | Compar- | Compar- | Compar- | Compar- | Compar- | Compar- | Compar- | Compar- | Compar- | Compar- | Compar- |
|---|---|---|---|---|---|---|---|---|---|---|---|
| | ative | ative | ative | ative | ative | ative | ative | ative | ative | ative | ative |
| | Exam- | Exam- | Exam- | Exam- | Exam- | Exam- | Exam- | Exam- | Exam- | Exam- | Exam- |
| | ple 34 | ple 35 | ple 36 | ple 37 | ple 38 | ple 39 | ple 40 | ple 41 | ple 42 | ple 43 | ple 44 |
| Collagen | 10000 mg | ← | ← | ← | ← | ← | ← | ← | ← | ← | ← |
| peptide | | | | | | | | | | | |
| Phosphoric | | | | 180 mg | | | | | | | |
| acid | | | | | | | | | | | |
| Sodium | | | | | 180 mg | | | | | | |
| metaphosphate | | | | | | | | | | | |
| Potassium | | | | | | 180 mg | | | | | |
| metaphosphate | | | | | | | | | | | |
| Sodium | | | | | | | 180 mg | | | | |
| pyrophosphate | | | | | | | | | | | |
| decahydrate | | | | | | | | | | | |
| L-ascorbic | | | | 1500 mg | | | | | | | |
| acid | | | | | | | | | | | |
| Citric acid | 1200 mg | | | | 900 mg | 900 mg | 900 mg | 500 mg | 500 mg | | 500 mg |
| Tartaric acid | | 1200 mg | | | | | | 500 mg | | 500 mg | |
| Malic acid | | | 1200 mg | | | | | | 500 mg | 500 mg | |
| Succinic acid | | | | | | | | | | | |
| Fumaric acid | | | | | | | | | | | 500 mg |
| Lactic acid | | | | | | | | | | | |
| L-lysinc | 200 mg | ← | ← | ← | ← | ← | ← | ← | ← | ← | ← |
| Erythritol | 1200 mg | ← | ← | ← | ← | ← | ← | ← | ← | ← | ← |
| Sucralose | 7.2 mg | ← | ← | ← | ← | ← | ← | ← | ← | ← | ← |
| Acesulfame K | 8.4 mg | ← | ← | ← | ← | ← | ← | ← | ← | ← | ← |
| Fragrance | appropriate | ← | ← | ← | ← | ← | ← | ← | ← | ← | ← |
| Water | appropriate | ← | ← | ← | ← | ← | ← | ← | ← | ← | ← |
| Liquid | 50 mL | ← | ← | ← | ← | ← | ← | ← | ← | ← | ← |
| measure | | | | | | | | | | | |
| Liquid pH | 3.81 | 3.46 | 3.68 | 4.03 | 4.05 | 4.08 | 4.12 | 3.78 | 3.84 | 3.73 | 3.69 |
| Evaluation | E | E | E | *F | *F | *F | *F | E | E | E | E |

As shown in Table 1 to Table 2, in the beverage composition including 3,333 mg/10 mL of the collagen peptide, any beverage composition in Examples 1 to 23 in which phosphoric acid and other acidifier were included and the pH was set to 4.0 or less was a beverage composition provided with moderately acidic taste and excellent flavor. Furthermore, it was confirmed that the flavor of the beverage compositions in Examples 1 to 7 and 11 to 23 containing at least one kind among citric acid, tartaric acid and malic acid as an acidifier except phosphoric acid was more excellent.

In contrast, as shown in Table 3 to Table 4, since the pH exceeded 4.0 in Comparative Examples 1 to 7 and 13 to 17, they were unsuitable from the viewpoint of the antiseptic property. In particular, in Comparative Examples 13 to 17 using a phosphoric acid salt such as sodium metaphosphate, it was difficult to set the pH to 4.0 or less even a phosphoric acid salt was used in the same amount as phosphoric acid and other acidifier in a case where the pH was 4.0 or less was used together in the same amount. In addition, in Comparative Example 11 and Comparative Example 12 in which only phosphoric acid was used as an acid for controlling the pH, the flavor was lacked in a refreshing feeling, and in Comparative Examples 8 to 10 and 18 to 21 in which phosphoric acid was not used, stimulation of the acidic taste became stronger and thus it was difficult to obtain a preferred flavor.

The similar tendency was obtained in the beverage compositions containing 2,500 mg/10 mL of the collagen peptide (Table 5 and Table 6, Examples 24 to 35, Comparative Examples 22 to 33) and the beverage compositions containing 2,000 mg/10 mL of the collagen peptide (Table 7 and Table 8, Examples 36 to 47, Comparative Examples 34 to 44).

According to the present invention, it is found that the beverage composition which includes the collagen peptide having a high concentration and has moderately acidic taste and excellent flavor in a pH range in which the pH is 4.0 or less is obtained.

What is claimed is:

1. A beverage composition comprising:
2,000 mg/10 mL or more of a low molecular collagen peptide having an average molecular weight of 3,000 or less; and
two or more kinds of acidifiers containing phosphoric acid,
wherein the pH is 4.0 or less.

2. The beverage composition according to claim 1,
wherein a concentration of the phosphoric acid is from 20 mg/10 mL to 200 mg/10 mL with respect to a volume of the composition.

3. The beverage composition according to claim 1,
wherein the acidifier includes at least one kind selected from a group consisting of phosphoric acid, citric acid, tartaric acid, malic acid, ascorbic acid, lactic acid, succinic acid and fumaric acid.

4. The beverage composition according to claim 2,
wherein the acidifier includes at least one kind selected from a group consisting of phosphoric acid, citric acid, tartaric acid, malic acid, ascorbic acid, lactic acid, succinic acid and fumaric acid.

5. The beverage composition according to claim 1 further comprising:
at least one kind of amino acid selected from a group consisting of lysine, proline and ornithine.

6. The beverage composition according to claim 2 further comprising:
at least one kind of amino acid selected from a group consisting of lysine, proline and ornithine.

7. The beverage composition according to claim 3 further comprising:
at least one kind of amino acid selected from a group consisting of lysine, proline and ornithine.

8. The beverage composition according to claim 4 further comprising:
at least one kind of amino acid selected from a group consisting of lysine, proline and ornithine.

9. The beverage composition according to claim 1 further comprising:
at least one kind of a sweetener with high sweetness degree selected from a group consisting of aspartame, thaumatin, stevia, sucralose and acesulfame potassium.

10. The beverage composition according to claim 2 further comprising:
at least one kind of a sweetener with high sweetness degree selected from a group consisting of aspartame, thaumatin, stevia, sucralose and acesulfame potassium.

11. The beverage composition according to claim 3 further comprising:
at least one kind of a sweetener with high sweetness degree selected from a group consisting of aspartame, thaumatin, stevia, sucralose and acesulfame potassium.

12. The beverage composition according to claim 4 further comprising:
at least one kind of a sweetener with high sweetness degree selected from a group consisting of aspartame, thaumatin, stevia, sucralose and acesulfame potassium.

13. The beverage composition according to claim 5 further comprising:
at least one kind of a sweetener with high sweetness degree selected from a group consisting of aspartame, thaumatin, stevia, sucralose and acesulfame potassium.

14. The beverage composition according to claim 6 further comprising:
at least one kind of a sweetener with high sweetness degree selected from a group consisting of aspartame, thaumatin, stevia, sucralose and acesulfame potassium.

15. A packaged beverage comprising:
the beverage composition according to claim 1.

16. A packaged beverage comprising:
the beverage composition according to claim 2.

17. A packaged beverage comprising:
the beverage composition according to claim 3.

18. A packaged beverage comprising:
the beverage composition according to claim 4.

19. A packaged beverage comprising:
the beverage composition according to claim 5.

20. A packaged beverage comprising:
the beverage composition according to claim 6.
